(19) United States
(12) Patent Application Publication
(10) Pub. No.: US 2019/0313212 A1
(43) Pub. Date: Oct. 10, 2019

(54) METHOD AND APPARATUS FOR PROVIDING TERMINAL MOBILITY EVENT NOTIFICATION SERVICE IN WIRELESS COMMUNICATION SYSTEM

(71) Applicant: Samsung Electronics Co., Ltd., Suwon-si (KR)

(72) Inventors: Jicheol LEE, Suwon-si (KR); Beomsik BAE, Suwon-si (KR); Jungshin PARK, Suwon-si (KR); Kisuk KWEON, Suwon-si (KR); Sangjun MOON, Suwon-si (KR)

(21) Appl. No.: 16/376,295

(22) Filed: Apr. 5, 2019

(30) Foreign Application Priority Data
Apr. 6, 2018 (KR) 10-2018-0040213

(51) Int. Cl. H04W 4/029; H04W 4/021

(52) U.S. Cl. CPC H04W 4/029; H04W 84/042; H04W 4/021

(57) ABSTRACT

The disclosure relates to a communication scheme and a system for combining a 5G communication system for supporting a higher data rate after 4G systems with IoT technology. The disclosure relates to a wireless communication system and, more particularly, to a method and an apparatus for providing a terminal mobility event notification service in a cellular wireless communication system (5G system).

### CROSS-REFERENCE TO RELATED APPLICATION

This application is based on and claims priority under 35 U.S.C. 119 to Korean Patent Application No. 10-2018-0040213 filed on Apr. 6, 2018 in the Korean Intellectual Property Office, the disclosure of which is herein incorporated by reference in its entirety.

### BACKGROUND

### 1. Field

The disclosure relates to a wireless communication system and, more particularly, to a method and an apparatus for providing a terminal mobility event notification service in a wireless communication system (5G system).

### 2. Description of Related Art

The below information is presented as background information only to assist with an understanding of the disclosure. No determination has been made, and no assertion is made, as to whether any of the above might be applicable as prior art with regard to the disclosure.

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

Meanwhile, 3GPP that is in charge of cellular mobile communication standards has named a new core network structure a 5G core (5GC), in order to accomplish evolution from existing 4G LTE systems to 5G systems, and has been conducting standardization.

The 5GC provides the following differentiated functions compared with the evolved packet core (EPC), which is the existing network core for 4G:

Firstly, the 5GC has introduced a network slice function. As a requirement of 5G, the 5GC needs to support various kinds of terminal types and services, such as enhanced mobile broadband (eMBB), ultra-reliable low latency communications (LRLLC), and massive machine type communications (mMTC). Such terminals/services have different requirements for the core network. For example, the eMBB service requires a high data rate, and the URLLC service requires high stability and low latency. A network slice scheme has been proposed as a technology for satisfying such various service requirements.

According to the network slice scheme, a physical network is virtualized such that multiple logical networks are obtained, and respective network slice instances (NSI) may have different characteristics. Accordingly, respective NSIs have network functions (NFs) conforming to characteristics thereof and can satisfy various service requirements. Respective terminals are assigned with NSIs according to the characteristics of required services such that various 5G services can be supported efficiently.

Secondly, the 5GC can facilitate network virtualization paradigm support through separation between a mobility management function and a session management function. In existing 4G LTE, all terminals can be provided with services in the network through signaling exchange with single core equipment referred to as a mobility management entity (MME) that is in charge of registration, authentication, mobility management, and session management functions. However, in the case of the 5G, the number of terminals increases exponentially, and the mobility and traffic/session characteristics that need to be supported according to terminal types are subdivided. If all functions are supported by single equipment such as the MME, the scalability (adding entities according to required functions) is inevitably degraded. Therefore, various functions are being developed on the basis of a structure that separates the mobility management function and the session management function, in order to improve the scalability, in terms of the signaling load and the complexity of the function/implementation of the core equipment that is in charge of the control plane.

### SUMMARY

The disclosure provides a method for providing a terminal mobility notification service in response to a consumer NF request in a 5GC. The disclosure proposes a method wherein, if an access and mobility management function (AFM) is requested to provide a report on terminal mobility by providing explicit conditions regarding event expiration such as the number of event reports and the period thereof, the AMF that supports the same provides a mobility reporting service.

According to an embodiment, if many NF service consumers use a terminal mobility reporting service provided by an AMF, the many NF service consumers may not perform an unsubscription procedure explicitly even after a notification is completed, and may continuously maintain the HTTP/2 persistent connection. Such a case may occur frequently. If such a phenomenon occurs, the increased number of TCP connections that are not used may waste system resources. Accordingly, the disclosure proposes a method for preventing the same.

The disclosure also proposes a method for determining whether or not a terminal exists in an area of interest by an AMF. Particularly, the disclosure proposes a method wherein the AMF determines whether or not a terminal exists in a requested terminal area-of-interest when the AMF cannot accurately confirm the location of the terminal when the terminal is in a connection management (CM)-CONNECTED state due to introduction of RRC inactive.

According to the disclosure, if an NF desires a notification of a mobility event regarding a terminal area-of-interest in a 5GC network, the NF can use the same. For example, when a policy control function (PCF) has a different type of billing in a designated area, the PCF may determine a different billing policy at each terminal location. When a session management function (SMF) reallocates a user plane function (UPF) in a designated area, the SMF may allocate a different UPF at each terminal location. The SMF can be used when the state regarding the PDU session should be changed in a local area data network (LADN) area, or when packets should be blocked. The SMF can be used for a service that requires terminal mobility, such as an emergency service or lawful interception.

The disclosure provides a method wherein the AMF can determine a terminal mobility event reporting expiration condition, announce a final report regarding the same, and disconnect persistent connection with the NF that has subscribed to the reporting service. Accordingly, the system resource of the AMF can be protected from a client who maintains persistent connection after the reporting desired by the AMF expires.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network structure of a 5G system and an interface thereof;

FIG. 2 illustrates a terminal mobility reporting procedure;

FIG. 3 illustrates an NG-RAN location movement reporting procedure;

FIG. 4 illustrates area classification according to a registration area and an area of interest;

FIG. 5 illustrates area classification according to an RNA notification area and an area of interest;

FIG. 6 illustrates an AMF according to the disclosure;

FIG. 7 illustrates an NG-RAN according to the disclosure; and

FIG. 8 illustrates an NF-service consumer according to the disclosure.

### DETAILED DESCRIPTION

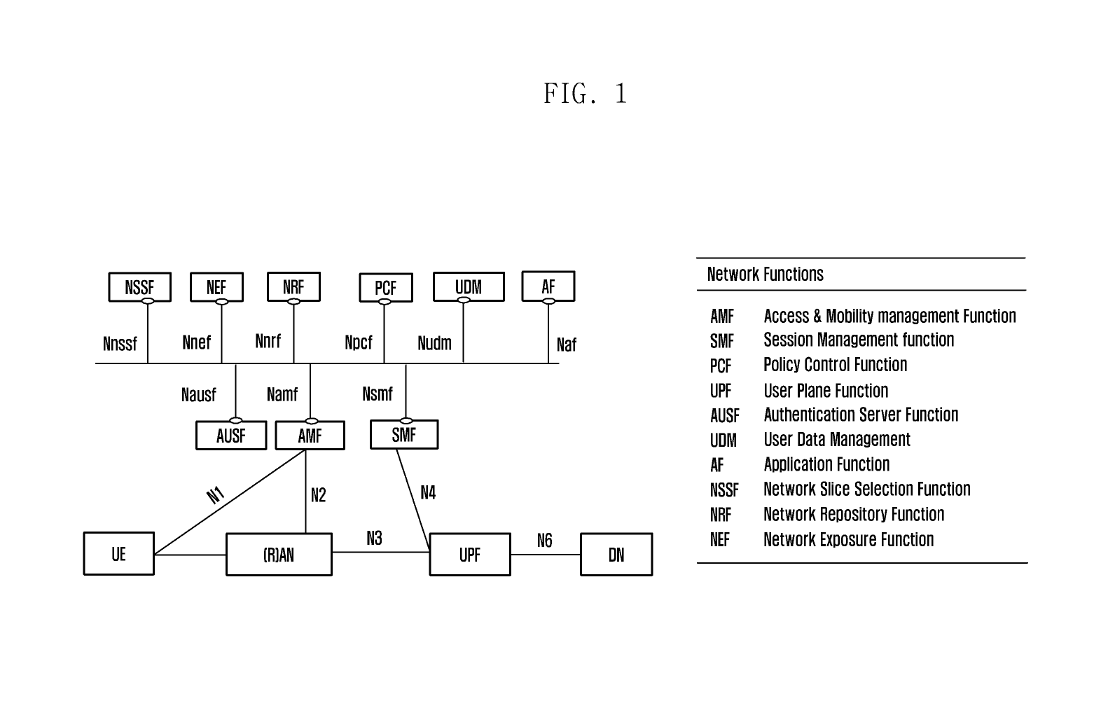

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, an embodiment of the disclosure will be described in detail with reference to the accompanying drawings. In the following description of the disclosure, a detailed description of known functions or configurations incorporated herein will be omitted when it may make the subject matter of the disclosure rather unclear. The terms which will be described below are terms defined in consideration of the functions in the disclosure, and may be different according to users, intentions of the users, or customs. Therefore, the definitions of the terms should be made based on the contents throughout the specification. Hereinafter, a base station refers to an entity that allocates resources to terminals, and may be at least one of an eNode B, a Node B, a base station (BS), a radio access network (RAN), an access network (AN), a RAN node, a wireless access unit, a base station controller, or a node on a network. A terminal may include user equipment (UE), a mobile station (MS), a cellular phone, a smartphone, a computer, or a multimedia system capable of performing a communication function. As used herein, a downlink (DL) refers to a path of wireless transmission of a signal from a base station to a terminal, and an uplink (UL) refers to a path of wireless transmission of a signal from a terminal to a base station. Although embodiments of the disclosure will hereinafter be described in connection with an exemplary LTE or LTE-A system, embodiments of the disclosure are also applicable to other communication systems having similar technical backgrounds or channel types. Moreover, embodiments of the disclosure are applicable to other communication systems, through partial modifications, as long as the same are not deemed by a person skilled in the art to substantially deviate from the scope of the disclosure.

FIG. 1 illustrates a network architecture for a 5G system.

The disclosure describes a terminal mobility event notification service. An AMF provides a consumer NF with a terminal mobility notification service. The consumer NF subscribes to the terminal mobility event notification service together with the following parameters through the AMF.

Event report type

Area of interest

Event reporting-related information (reporting mode, number of reports, reporting period, event reporting condition (for example, when a target terminal enters a designated area of interest (that is, the terminal area-of-interest value changes to IN)))

Notification address

Target devices

If the NG-RAN supports RRC inactive, the AMF requests the RAN to conduct NG-RNA location reporting in order to track the terminal's area-of-interest mobility in a CM-CONNECTED state.

When subscribed to a terminal area-of-interest mode, the AMF determines whether or not the terminal exists within the area of interest when a registration procedure, a handover procedure, an NG-RAN location reporting procedure, or an AN release procedure occurs.

When the status regarding whether or not the terminal exists within the area of interest is changed, the AMF reports the terminal area-of-interest movement to the subscribed NF.

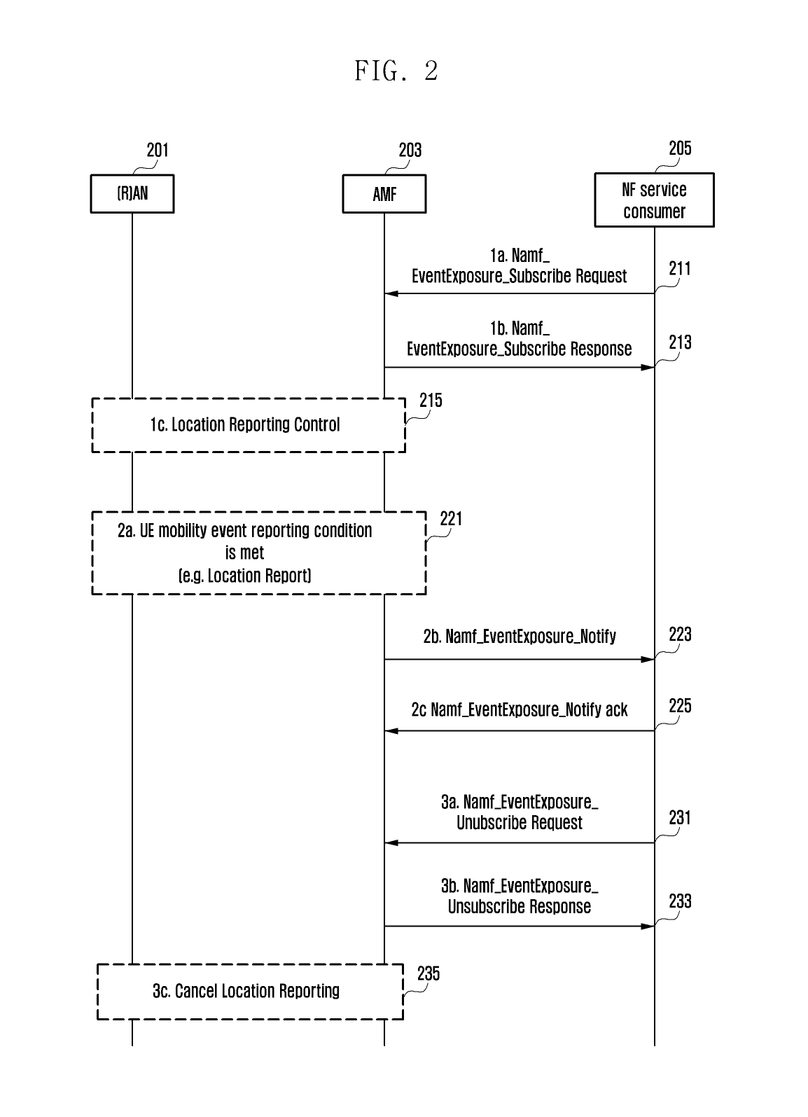

Procedures of the terminal's mobility event subscription, reporting, and cancellation are described in FIG. 2.

The NF consumer (for example, SMF, PCF, or NEF) 205 subscribes to a terminal mobility event notification service through a terminal mobility event subscription procedure (211 and 213 in FIG. 2). The AMF 203 determines event occurrence corresponding to a subscribed terminal mobility event reporting condition and, when an event has occurred (221), reports the terminal mobility event by using the notification address (223 in FIG. 2). The NF consumer 205 may acknowledge the reporting (225 in FIG. 2) and request cancellation of the terminal mobility event notification subscription if needed (231 in FIG. 2).

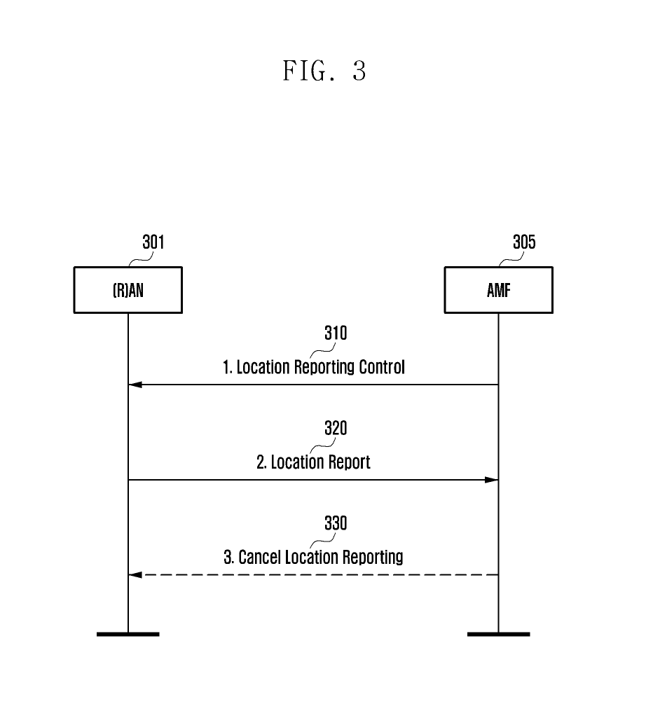

NG-RAN terminal location reporting is conducted such that, if the corresponding terminal is in a CM-CONNECTED state, the NG-RAN 201 reports the terminal's current location or whether or not the terminal is in the area of interest to the AMF 305. The detailed procedure is described in FIG. 3.

In 310 of FIG. 3, the AMF 305 transmits a location reporting control message to the NG-RAN 301. The location reporting message may include a reporting type, a location reporting level, an area of interest, and a request reference ID. The reporting type may be one-time reporting, continuous reporting, or area-of-interest change reporting. The location reporting level may designate traffic area-based reporting, cell-based reporting, or reporting including both. When the reporting type is area-of-interest change reporting, the location report control message includes an area of interest. The area of interest may be configured as a list of cells or a list of traffic areas, and a single area of interest may be identified by a request reference ID that can reference the same.

In 320 of FIG. 3, the NG-RAN 301 transmits a location report message to the AMF 305. The location report message may include a terminal location, information regarding whether the terminal exists in the area of interest (UE Presence in Area of Interest), a request reference ID, and a timestamp. The terminal location may correspond to a cell ID or a traffic area ID (tracking area index). The NG-RAN 301 informs the AMF 305 of the lastly known terminal location and the time when the terminal location is known, by using a timestamp. The NG-RAN 301 determines whether or not the terminal exists in the area of interest. If the information has been changed, the location repot message may include the request reference ID and information regarding whether the terminal exists in the area of interest, which may have the value of IN, OUT, or UNKNOWN.

In 330 of FIG. 3, the AMF 305 transmits a cancel location reporting message to the NG-RAN 301. The cancel location reporting message includes a reporting type and a request reference ID. If the reporting type is a one-time reporting type or a continuous reporting type, the NG-RAN 301 receives the cancel location reporting message and terminates reporting of the corresponding type. If the reporting type is area-of-interest change reporting, area-of-interest reporting indicated by the request reference ID is terminated. When the cancel location reporting message includes multiple request reference IDs, reporting of all of the multiple areas of interest is ended. Such a cancel location procedure is performed when the AMF 305 has determined to terminate event subscription that has caused the NG-RAN location reporting request. The condition for the AMF 305 to determine event termination may correspond to reporting period expiration or movement of the terminal out of the area of interest.

### First Embodiment

In the first embodiment, a terminal mobility event subscription procedure will be described.

In 211 of FIG. 2, the NF consumer 205 such as SMF, PCF, or NEF sends a Namf_EventExposure_Subscribe message to the AMF 203 and thus subscribes to a terminal mobility event notification service. The following factors are included during subscription:

Event report type

Area of interest

Event reporting-related information (reporting mode, number of reports, reporting period, event reporting condition (for example, when a target terminal enters a designated area of interest (that is, the terminal area-of-interest value changes to IN)))

Notification address

Target devices

The AMF 203 may designate the condition for termination or expiration of the event reporting by using the reporting mode, the number of reports, and the reporting period included in the event reporting-related information. Alternatively, the AMF 203 may determine the event reporting subscription termination condition by using the event reporting-related information. For example, when the number of event reports is three, the AMF 203 may terminate event reporting subscription after three event reports. Alternatively, when the event reporting period is three hours, the AMF 203 may terminate event reporting subscription when three houses pass after subscribing to the event reporting. When the event reporting type is an area-of-interest type, and when the event has a specific value (for example, OUT) regarding whether or not the terminal exists in the area of interest (for example, when the terminal moves out of the area of interest), the AMF 203 may designate event termination. Similarly, when the value regarding whether or not the terminal exists in the area of interest is IN, that is, when the terminal enters the area of interest, the AMF 203 may designate event termination.

When the AMF 203 does not support the subscription request after successful event subscription, the AMF 203 may refuse the request of the NF consumer 205 in 213 of FIG. 2. For example, the AMF 203 may refuse the terminal area-of-interest mobility reporting request regarding a LADN data network name (DNN) that has not been set.

In 215 of FIG. 2, the AMF 203 checks the following conditions and, if NG-RAN location reporting is necessary, performs an NG-RAN location reporting request procedure.

Conditions:

The report mode to which the NF service consumer has subscribed corresponds to a report on the area of interest of the terminal or a report on the location of the terminal;

The current CM state of the terminal is CM-CONNECTED state;

The terminal supports RRC Inactive; and

The NG-RAN supports RRC Inactive.

According to an embodiment, the AMF 203 checks the above information and requests the NG-RAN 201 to conduct NG-RAN location reporting.

After performing step 215 of FIG. 2, the AMF 203 checks the following conditions and, if A N2 notification reporting is necessary, performs an N2 notification request procedure.

Conditions:

The report to which the NF service consumer has subscribed corresponds to a report on the terminal condition change;

The current CM state of the terminal is CM-CONNECTED state;

The terminal supports RRC inactive; and

The NG-RAN supports RRC inactive.

According to an embodiment, the AMF 203 checks the above information and performs a procedure of requesting the NG-RAN 201 to provide an N2 notification.

### Second Embodiment

In the second embodiment, a terminal mobility event reporting procedure will be described.

In 221 of FIG. 2, the AMF 203 determines event occurrence corresponding to a subscribed terminal mobility event reporting condition. When the subscription request corresponds to terminal area-of-interest mobility reporting, the AMF 203 determines whether or not the terminal exists in the area of interest and, when a change has occurred, performs a reporting procedure 223. After successful reporting, the AMF 203 inspects the reporting expiration condition, thereby confirming whether or not final reporting is made. The AMF 203 inspects the following reporting expiration conditions:

The number of event reports is equal to the maximum number of event reports requested during the subscription procedure;

When a report due to reporting time elapse is determined, confirm whether or not the final report is made

When subscribed to an event, the condition of the terminal area-of-interest is designated (for example, IN or OUT), and expiration is instructed after condition reporting

In 223 of FIG. 2, the AMF 203 reports a terminal mobility event by using the notification address. When the AMF 203 confirms the final report, the AMF 203 adds an indicator that indicates the final report and transmits the same. The indicator that indicates the final report is added to the terminal mobility report message as an additional information element. After receiving the indictor, the NF consumer 205 may explicitly perform a terminal mobility subscription cancellation procedure through step 231. After transmitting the final report, the AMF 203 may forcibly terminates the HTTP/2 persistent connection with the NF consumer 205.

When the AMF 203 has determined the final report on the basis of reporting expiration and then performed the final report, the AMF 203 cancels the requested NG-RAN location reporting.

### Third Embodiment

In the third embodiment, a terminal mobility event subscription cancelation procedure will be described.

Before performing step 231 of FIG. 2, the NF consumer 205 determines to cancel the terminal mobility event reporting subscription. The NF consumer 205 determines to cancel the terminal mobility event reporting subscription when event reporting is necessary once, when only a predetermined number of event reports are necessary, or when the corresponding reporting has been accomplished.

In step 231 of FIG. 2, the NF consumer 205 requests the AMF 203 to cancel the terminal mobility event reporting subscription.

In 233 of FIG. 2, the AMF 203 determines to cancel the terminal mobility event reporting and responds to the NF consumer 205 that has made the request.

In 235 of FIG. 2, the AMF 203 performs a procedure of canceling NG-RAN location reporting that the AMF 203 has requested the NG-RAN 201 to conduct.

### Fourth Embodiment

In the fourth embodiment, an AMF operation for the AMF to determine a condition for requesting or cancelling NG-RAN location reporting will be described.

After successfully performing terminal mobility event notification subscription, the AMF manages statistic information regarding the terminal mobility event reporting (for example, the number of event reports).

According to the event notification subscription information, the AMF determines whether to request or cancel an N2 notification for reporting the terminal's RRC state (RRC connected or inactive) during NG-RAN location reporting or RRC inactive application. For example, the AMF may cancel the NG-RAN location reporting when the event reporting period has expired, or when the number of event reports reaches the maximum number of event reports.

After a successful handover procedure, the AMF may request the target NG-RAN node to report the NG-RAN location. Similarly, the AMF may request NG-RAN location reporting when the terminal's state has changed to CM-CONNECTED by performing a successful UE-triggered service request procedure.

### Fifth Embodiment

In the fifth embodiment, a method for determining whether or not the terminal exists in the area of interest by the AMF is described.

If terminal is in CM-CONNECTED state, and if NG-RAN location reporting regarding the terminal's area-of-interest change has been requested, the AMF determines the terminal area-of-interest by means of the value (IN, OUT, or UNKNOWN) of location reporting by the NG-RAN.

The AMF determines whether or not the terminal moves from the area of interest in a registration procedure, a handover procedure, a procedure of UE-triggered request in CM-IDLE, an NG-RAN location reporting procedure, and an AN release request, as follows.

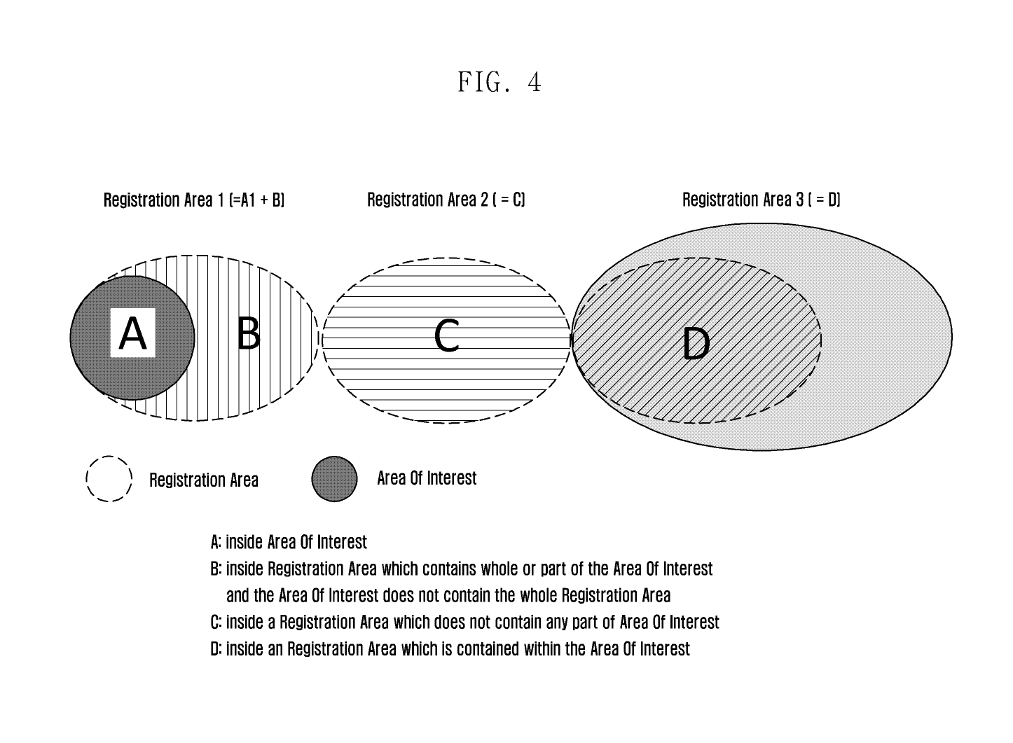

The AMF determines whether or not the terminal exists in the area of interest according to the relative location of the target terminal in view of the terminal's CM state and the registration area and the area of interest described in Table 1 and FIG. 4, as follows:

Inside the area of interest (IN)

When the terminal is in the area of interest, and when the terminal is in CM-CONNECTED state (nos. 1 and 7 in Table 1)

When the terminal is in a registration area included in the area of interest (nos. 7 and 8 in Table 1)

Outside the area of interest (OUT)

When the terminal is in a registration area including the area of interest but is outside the area of interest, and when the terminal is in CM-CONNECTED state (no. 3 in Table 1)

When the terminal is in a registration area that does not include the area of interest (nos. 5 and 6 in Table 1)

Existence in the area of interest unknown (UNKNOWN)

When the terminal is in a registration area including the area of interest, when the area of interest does not include the entire registration area, and when the terminal is in CM-IDLE state (nos. 2 and 4 in Table 1).

In order to determine whether or not the terminal exists in the area of interest according to the registration area and the terminal's CM state, the AMF uses a classification method based on the registration area and the area of interest as illustrated in FIG. 4.

According to the area classification method of FIG. 4 and the terminal's CM state, the AMF determines whether or not the terminal exists in the area of interest under the eight conditions identified in Table 1.

TABLE 1

| | Location | | | |
|---|---|---|---|---|
| | | | | Area D |
| | | Area B (vertical | Area C | (diagonal |
| | | hatching) | (horizontal | hatching) |
| | | Inside a registration | hatching) | Inside a |
| | Area A (gray | area including the | Registration | registration |
| | marking) | area-of-interest, | area not | area included |
| | Inside area-of- | outside the area-of- | including the | in the area-of- |
| CM state | interest | interest | area-of-interest | interest |
| CM- | Inside area | Outside the area | Outside the | Inside the area |
| CONNECTED | (no. 1) | (no. 3) | area (no. 5) | (no. 7) |
| CM-IDLE | Area location | Area location | Outside the | Inside the area |
| | unknown (no. | unknown (no. 4) | area (no. 6) | (no. 8) |
| | 2) | | | |

Table 1. Method for determining whether or not the terminal exists in the area of interest according to the registration area and the terminal's CM state

### Sixth Embodiment

In the sixth embodiment, a method for determining whether or not the terminal exists in the area of interest on the basis of NG-RAN location reporting by the AMF will be described.

In order to determine movement of the terminal with regard to the area of interest in CM-CONNECTED state, the AMF requests the NG-RAN to conduct NG-RAN mobility reporting regarding a report on the terminal area-of-interest.

After receiving the location reporting request from the AMF, the NG-RAN determines whether or not the terminal exists in the area of interest in the following manner.

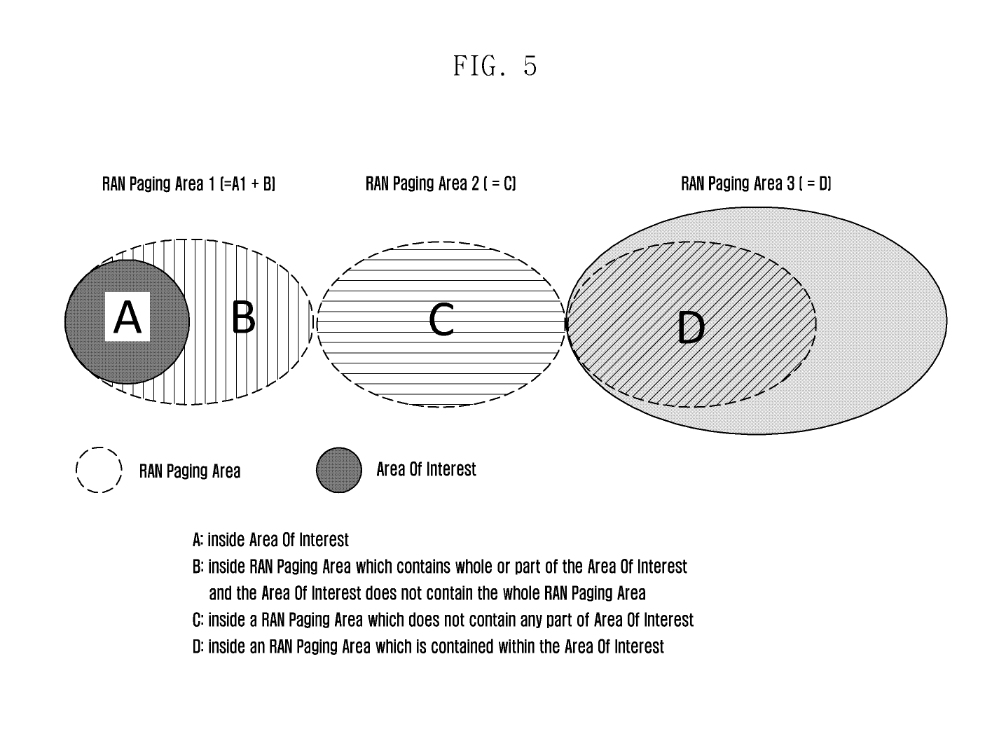

The AMF determines whether or not the terminal exists in the area of interest according to the relative location of the target terminal in view of the terminal's CM state and the RAN notification area and the area of interest described in Table 2 and FIG. 5, as follows:

Inside the area of interest (IN) (nos. 1, 7, and 8 in Table 2)

When the terminal is in the area of interest, and when the terminal is in RRC connected state (nos. 1 and 7 in Table 2)

When the terminal is in an RAN area included in the area of interest (nos. 7 and 8 in Table 2)

Outside the area of interest (OUT) (nos. 3, 5, and 6 in Table 2)

When the terminal is in a registration area including the area of interest but is outside the area of interest, and when the terminal is in RRC connected state (no. 3 in Table 2)

When the terminal is in a registration area that does not include the area of interest (nos. 5 and 6 in Table 2)

Location in the area of interest unknown (UNKNOWN) (nos. 2 and 4 in Table 2)

When the terminal is in a registration area including the area of interest, when the area of interest does not include the entire registration area, and when the terminal is in RRC inactive state (nos. 2 and 4 in Table 2).

When the status regarding whether or not the terminal exists in the area of interest has changed, the NG-RAN reports the same to the AMF. The AMF receives the report regarding the status regarding whether or not the terminal exists in the area of interest from the NG-RAN, confirms whether or not there is any change, and determines whether or not the terminal has moved with regard to the area of interest.

In order to determine whether or not the terminal exists in the area of interest according to the RAN notification area (RNA) and the terminal's RRC state, the NG-RAN uses a classification method based on the RAN notification area and the area of interest as illustrated in FIG. 5.

According to the area classification method of FIG. 5 and the terminal's RRC state, the NG-RAN determines whether or not the terminal exists in the area of interest under the eight conditions identified in Table 2.

TABLE 2

| | Location | | | |
|---|---|---|---|---|
| | | | | Area D |
| | | Area B (vertical | Area C | (diagonal |
| | | hatching) | (horizontal | hatching) |
| | Area A (gray | Inside an RNA area | hatching) | Inside an RNA |
| | marking) | including the area- | RNA area not | area included |
| | Inside area-of- | of-interest, outside | including the | in the area-of- |
| RRC state | interest | the area-of-interest | area-of-interest | interest |
| RRC Connected | Inside area | Outside the area | Outside the | Inside the area |
| | (no. 1) | (no. 3) | area (no. 5) | (no. 7) |
| RRC inactive | Area location | Area location | Outside the | Inside the area |
| | unknown (no. | unknown (no. 4) | area (no. 6) | (no. 8) |
| | 2) | | | |

Table 2. Method for determining whether or not the terminal exists in the area of interest according to the RNA notification area and the terminal's RRC state

### Seventh Embodiment

In the seventh embodiment, an overall method for determining whether or not the terminal exists in the area of interest by the AMF will be described. That is, the determining method in the fifth embodiment will be described together with a method wherein, when the NG-RAN supports the RRC inactive state, the AMF requests NG-RAN reporting, and the AMF receives an NG-RAN location report and determines whether or not the terminal exists in the area of interest.

The AMF determines whether or not the terminal moves from the area of interest in a registration procedure, a handover procedure, a procedure of UE-triggered service request in CM-IDLE, an NG-RAN location reporting procedure, and an AN release request, as follows.

Inside the area of interest (IN)

When the terminal is in the area of interest, and when the terminal is in CM-CONNECTED state (nos. 1 and 7 in Table 1 in the fourth embodiment)

When the terminal is in a registration area included in the area of interest (nos. 7 and 8 in Table 1 in the fourth embodiment), or

When the AMF has requested NG-RAN location reporting, and when the NG-RAN has reported that the terminal area-of-interest is IN (nos. 1, 7, and 8 in Table 2 in the fifth embodiment)

Outside the area of interest (OUT)

When the terminal is in a registration area including the area of interest but is outside the area of interest, and when the terminal is in CM-CONNECTED state (no. 3 in Table 1 in the fourth embodiment)

When the terminal is in a registration area that does not include the area of interest (nos. 5 and 6 in Table 1 in the fourth embodiment), or

When the AMF has requested NG-RAN location reporting, and when the NG-RAN has reported that the terminal area-of-interest is OUT (nos. 3, 5, and 6 in Table 2 in the fifth embodiment)

Existence in the area of interest unknown (UNKNOWN)

When the terminal is in a registration area including the area of interest, when the area of interest does not include the entire registration area, and when the terminal is in CM-IDLE state (nos. 2 and 4 in Table 1 in the fourth embodiment), or

When the AMF has requested NG-RAN location reporting, and when the NG-RAN has reported that the terminal area-of-interest is UNKNOWN (nos. 2 and 4 in Table 2 in the fifth embodiment).

### Eight Embodiment

The eighth embodiment relates to operations of the AMF after successful event subscription.

After successful event subscription, the AMF manages and updates statistics regarding mobility event reporting, such as the number of reported events. The AMF may determine to terminate event subscription according to event subscription information and event reporting statistics information with regard to the event to be reported. For example, event subscription may be terminated when the event reporting period expires, when the number of reported events reaches the maximum number of event reports, or when the target terminal enters or exits the designated area.

If the AMF determines to terminate event subscription, the AMF transmits the final event report identifier to the NF service consumer (or event consumer NF, subscriber NF). For reference, the NF service consumer means a network function (NF) subscribed to the event reporting service of the AMF, and may be referred to as an event consumer NF or a subscriber NF. Such an NF may be an SMF, a PCF, or an NEF. After transmitting the last event report to the NF service consumer, the AMF may release the connection with the NF service consumer (TCP connection or HTTP persistent connection) or the association therewith without waiting for an unsubscription request from the NF service consumer. If the event report includes the final report identifier, the NF service consumer may release the event subscription without sending an unsubscription request to the AMF.

If the NS service consumer determines to terminate the event subscription, the NF service consumer unsubscribes from the event by sending an unsubscription request to the AMF. Upon receiving the unsubscription request from the NF service consumer, the AMF terminates the event subscription. After terminating the event subscription, the AMF cancels any NG-RAN location report that may have been requested previously.

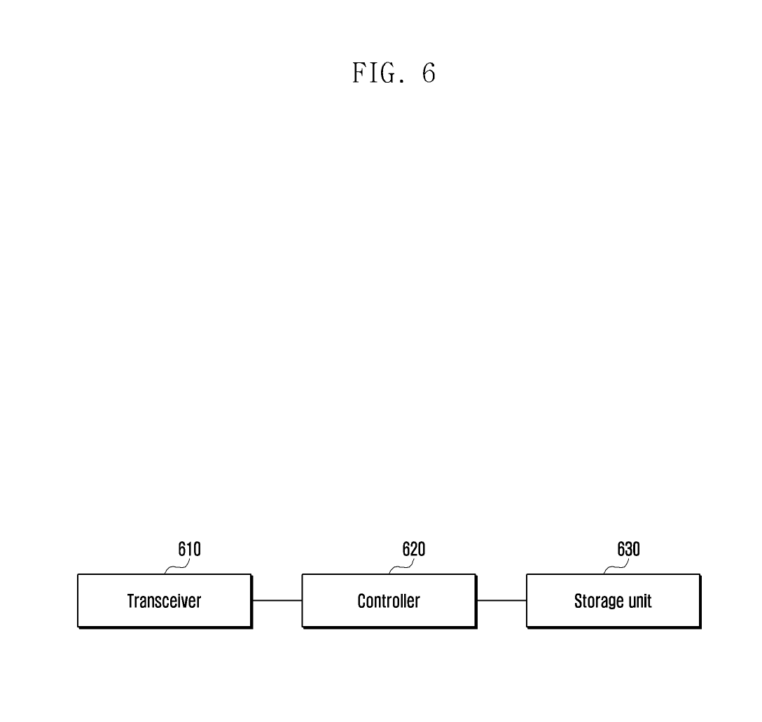

FIG. 6 illustrates an AMF according to the disclosure.

The AMF according to the disclosure may include a transceiver 610, a controller 620, and a storage unit 630. According to an embodiment, the controller 620 may determine an event reporting subscription expiration condition on the basis of event reporting-related information. For example, when the number of event reports is three, the controller 620 may terminate event reporting subscription after event reporting. In addition, according to an embodiment, the controller 620 may control the transceiver 610 so as to perform an NG-RAN location reporting request procedure when NG-RAN location reporting is necessary.

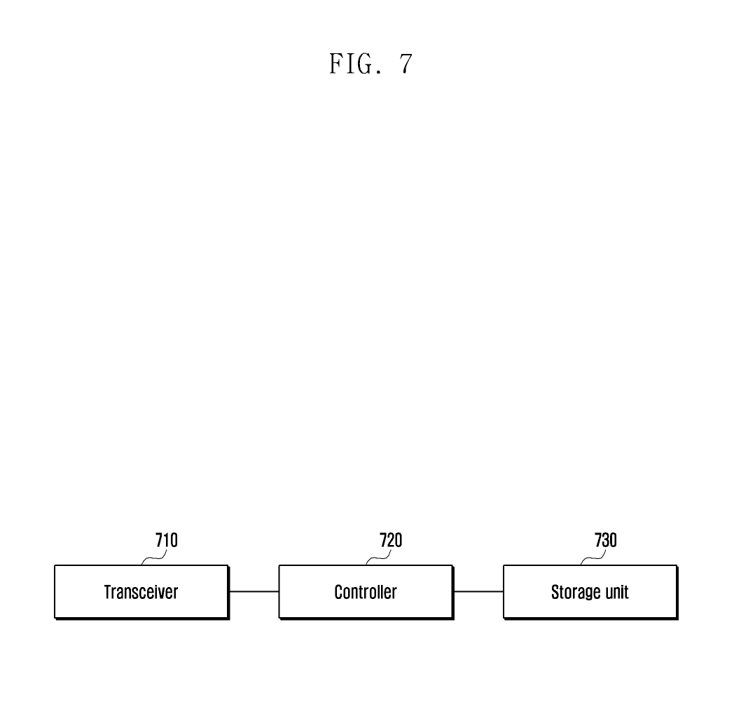

FIG. 7 illustrates an NG-RAN according to the disclosure.

The NG-RAN according to the disclosure may include a transceiver 710, a controller 720, and a storage unit 730. According to an embodiment, the controller 720 may control the transceiver 710 so as to transmit a location report message to the AMF. The message may include a terminal location, information regarding whether the terminal exists in the area of interest, a request reference ID, and a timestamp.

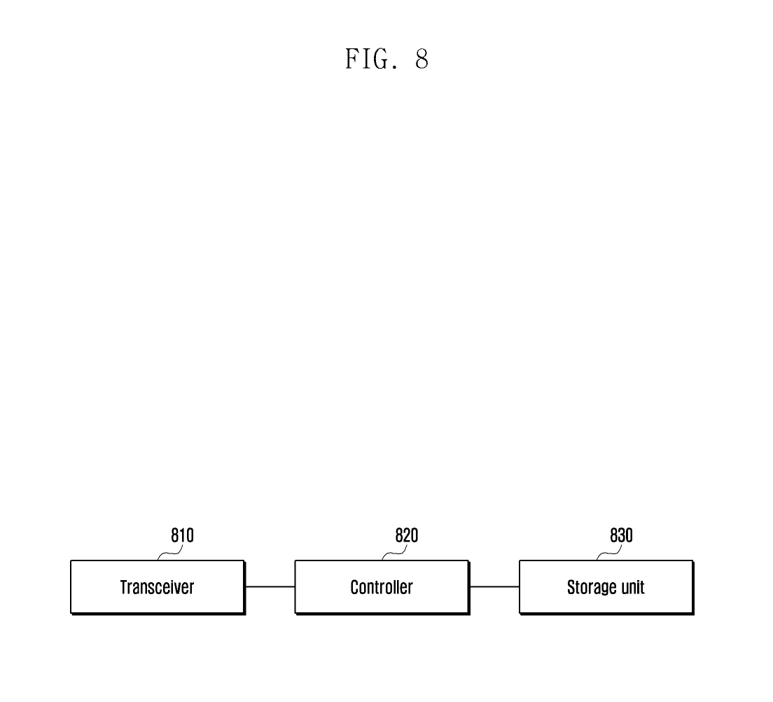

FIG. 8 illustrates an NF service consumer according to the disclosure.

The NF service consumer according to the disclosure may include a transceiver 810, a controller 820, and a storage unit 830. According to an embodiment, the NF service consumer may include an SMF, a PCF, or an NEF. According to an embodiment, the controller 820 may control the transceiver 810 so as to send an Namf_EventExposure_Subscribe message to the AMF, thereby subscribing to the terminal mobility event notification service.

The disclosure relates to a 5G or pre-5G communication system provided to support a higher data rate after 4G communication systems such as LTE.

According to an embodiment, the AMF performs the following procedure: when subscribing to a terminal mobility event, the AMF receives a subscription request message including an event reporting condition and an event expiration condition; when the event reporting condition is satisfied as a result of terminal movement, the AMF checks the expiration condition; and, in the case of expiration, the AMF sends a report including the final report indicator to the NF.

According to another embodiment, when the AMF receives a report on the area of interest with regard to a terminal, the AMF determines whether or not the terminal exists in the area of interest in view of the terminal's CM state, the registration area, and the area of interest in a registration procedure, a handover procedure, a procedure of requesting a service triggered by the terminal in CM-IDLE state, an NG-RAN location reporting procedure, and an AN release request. The AMF then reports a change thereof.

According to another embodiment, when the NG-RAN supports RRC inactive state, and if the AMF receives a report on the area of interest with regard to a terminal, the AMF requests an NG-RAN report and receives a report on whether or not the terminal exists in the area of interest from the NG-RAN. In CM-CONNECTED state, the AMF reports whether or not the terminal exists in the area of interest as received from the NG-RAN. In addition, in order to report the terminal's area-of-interest mobility in the CM-CONNECTED state, the NG-RAN determines whether or not the terminal exists in the area of interest in view of the terminal's RRC state, the RAN notification area, and the area of interest.

According to an embodiment, the AMF receives a condition regarding event reporting expiration in a terminal mobility subscription procedure and, when the RAN support RRC inactive, requests NG-RAN location reporting in order to track the terminal's location in the CM-CONNECTED state. If a mobility event occurs, the AMF checks the reporting expiration condition, confirms whether or not to make the final report, and reports the occurred event to the subscribed NF. The AMF indicates whether or not the report is final during reporting. After completing the final report, the AMF may voluntarily cut the persistent connection with the NF service consumer. After successfully completing the report, and if the final report has been conducted as a result of report expiration, the AMF performs a procedure of cancelling the NG-RAN location reporting that has been requested.

Meanwhile, the embodiments of the disclosure disclosed in the present specification and the drawings have been presented to easily explain technical contents of the disclosure and help comprehension of the disclosure, and do not limit the scope of the disclosure. That is, it is obvious to those skilled in the art to which the disclosure belongs that different modifications can be achieved based on the technical spirit of the disclosure. Further, if necessary, the above respective embodiments may be employed in combination. For example, parts of embodiments of the disclosure may be combined to operate a base station and a terminal.

Although the present disclosure has been described with various embodiments, various changes and modifications may be suggested to one skilled in the art. It is intended that the present disclosure encompass such changes and modifications as fall within the scope of the appended claims.

What is claimed is:

1. A method by an access and mobility management function (AMF) in a wireless communication system, the method comprising:
transmitting, to a base station, a first message for requesting location reporting;
receiving, from the base station a second message including information on an area of interest in response to the transmitting of the first message; and
determining a presence of a terminal in the area of interest based on the information, if the terminal is in a connection management (CM) CONNECTED state.

2. The method of claim 1, further comprising:
transmitting, to the base station, if the terminal is in the CM CONNECTED state and the base station is in radio resource control (RRC) inactive state, a third message to track the presence of the terminal in the area of interest.

3. The method of claim 2, wherein the third message is used for requesting N2 notification procedure.

4. The method of claim 1, wherein the determining of the presence of the terminal comprises:
determining the presence of the terminal in the area of interest as “IN”, if the terminal is inside the area of interest and the terminal is in the CM CONNECTED state; and
determining the presence of the terminal in the area of interest as “IN”, if the terminal is inside a registration area that is contained within the area of interest.

5. The method of claim 1, wherein the determining of the presence of the terminal comprises:
determining the presence of the terminal in the area of interest as “OUT”, if the terminal is outside the area of interest and the terminal is in the CM-CONNECTED state; and
determining the presence of the terminal in the area of interest as “OUT”, if the terminal is inside a registration area that does not contain the area of interest.

6. A method by a base station in a wireless communication system, the method comprising:
receiving, from an access and mobility management function (AMF), a first message for requesting location reporting; and
transmitting, to the AMF, a second message including information on an area of interest in response to the receiving of the first message; and
wherein the information is used for determining a presence of a terminal in the area of interest by the AMF, if the terminal is in connection management (CM) CONNECTED state.

7. The method of claim 6, further comprising:
receiving, from the AMF, if the terminal is in the CM CONNECTED state and the base station is in radio resource control (RRC) inactive state, a third message to track the presence of the terminal in the area of interest.

8. The method of claim 7, wherein the third message is used for requesting N2 notification procedure.

9. The method of claim 6, wherein the presence of the terminal in the area of interest is determined as “IN”, if the terminal is inside the area of interest and the terminal is in the CM CONNECTED state, and
wherein the presence of the terminal in the area of interest is determined as “IN”, if the terminal is inside a registration area that is contained within the area of interest.

10. The method of claim 6, wherein the presence of the terminal in the area of interest is determined as “OUT”, if the terminal is outside the area of interest and the terminal is in the CM CONNECTED state, and
wherein the presence of the terminal in the area of interest is determined as “OUT”, if the terminal is inside a registration area that does not contain the area of interest.

11. An access and mobility management function (AMF) in a wireless communication system, the AMF comprising:
a transceiver; and
a controller coupled with the transceiver and configured to:
control the transceiver to transmit, to a base station, a first message for requesting location reporting,
control the transceiver to receive, from the base station a second message including information on an area of interest in response to the transmitting of the first message, and
determine a presence of a terminal in the area of interest based on the information, if the terminal is in a connection management (CM) CONNECTED state.

12. The AMF of claim 11, wherein the controller is further configured to control the transceiver to transmit, to the base station, if the terminal is in the CM CONNECTED state and the base station is in radio resource control (RRC) inactive state, a third message to track the presence of the terminal in the area of interest.

13. The AMF of claim 12, wherein the third message is used for requesting N2 notification procedure.

14. The AMF of claim 11, wherein the controller is further configured to:
determine the presence of the terminal in the area of interest as “IN”, if the terminal is inside the area of interest and the terminal is in the CM CONNECTED state, and
determine the presence of the terminal in the area of interest as “IN”, if the terminal is inside a registration area that is contained within the area of interest.

15. The AMF of claim 11, wherein the controller is further configured to:
determine the presence of the terminal in the area of interest as “OUT”, if the terminal is outside the area of interest and the terminal is in the CM CONNECTED state, and
determine the presence of the terminal in the area of interest as “OUT”, if the terminal is inside a registration area that does not contain the area of interest.

16. A base station in a wireless communication system, the base station comprising:
a transceiver; and
a controller coupled with the transceiver and configured to:
control the transceiver to receive, from an access and mobility management function (AMF), a first message for requesting location reporting, and
control the transceiver to transmit, to the AMF, a second message including information on an area of interest in response to the receiving of the first message, and
wherein the information is used for determining a presence of a terminal in the area of interest by the AMF, if the terminal is in a connection management (CM) CONNECTED state.

17. The base station of claim 16, wherein the controller is further configured to control the transceiver to receive, from the AMF, if the terminal is in the CM CONNECTED state and the base station is in radio resource control (RRC) inactive state, a third message to track the presence of the terminal in the area of interest.

18. The base station of claim 17, wherein the third message is used for requesting N2 notification procedure.

19. The base station of claim 16, wherein the presence of the terminal in the area of interest is determined as “IN”, if the terminal is inside the area of interest and the terminal is in the CM CONNECTED state, and
wherein the presence of the terminal in the area of interest is determined as “IN”, if the terminal is inside a registration area that is contained within the area of interest.

20. The base station of claim 16, wherein the presence of the terminal in the area of interest is determined as “OUT”, if the terminal is outside the area of interest and the terminal is in the CM CONNECTED state, and
wherein the presence of the terminal in the area of interest is determined as “OUT”, if the terminal is inside a registration area that does not contain the area of interest.
